(19) United States
(12) Patent Application Publication
(10) Pub. No.: US 2014/0114716 A1
(43) Pub. Date: Apr. 24, 2014

(54) Method and system for proximity reminders

(71) Applicant: Moritz Tim Flögel, Hagen (DE)

(72) Inventor: Moritz Tim Flögel, Hagen (DE)

(21) Appl. No.: 13/998,328

(22) Filed: Oct. 20, 2013

Related U.S. Application Data
(60) Provisional application No. 61/795,540, filed on Oct. 20, 2012.

(51) Int. Cl. G06Q 10/10

(52) U.S. Cl. CPC G06Q 10/1095
USPC 705/7.19

(57) ABSTRACT

Among other things, a person who wants to give a digital reminder of an appointment can provide information from which the subject or task, the future time the location, and trigger can be determined or can employ saved information, such as scanned quick response code, from which the subject or task, the future time the location, and trigger condition can be determined.

### CROSS-REFERENCE TO RELATED APPLICATIONS

This application claims priority to U.S. Provisional Application Ser. No. 61/795,540, which was filed on Oct. 20, 2012, and the contents of which is incorporated here by reference.

### TECHNICAL FIELD

The present invention relates generally to mobile phone network environments, more particularly, to systems and methods for efficient and effective activity scheduling at geolocation sites.

### BACKGROUND

A typical user of a personal mobile phone makes use of social networking, business networking, and commercial transactions. Such a user needs to make appointments to meet others or to make a purchase in a specific location at a specific time. Typical examples would be meeting friends at a concert or meeting business colleagues for lunch at a restaurant, or visiting a store during a sale to make a purchase, traveling and organizing sightseeing tours.

### SUMMARY

In general in an aspect, in one embodiment, users input data in multiple ways, such as, but not limited to, via touch, via voice, via taking a picture, via utilization of a two dimensional code, matrix code, bar code, or quick response (QR) code. As an example, a user can scan a QR code they see on a billboard, at a train station, or in a store and the QR code contains information about the product, and most importantly the place to buy it, e.g. the local electronics store. The reminder is created and when the user attains proximity to the location of that store, which was obtained from the QR code, the user is reminded as the reminder is triggered by the user's geolocation. Moreover, in an aspect, in one embodiment, users can easily share any reminder with others who can be using any platform via multiple means such as via text message, via posting on social media websites, or via utilization of Twitter messaging. In general, in an aspect, in one embodiment, users can share reminders via such means as e-mail, social networks, via the mobile application to another user of the mobile application, via SMS/text messages, via near field communications (NFC), via radio frequency identification, RFID, communications, via two dimensional codes, bar codes, matrix codes, QR codes, and/or via Bluetooth communications. A user could, in one embodiment, create a reminder by launching the mobile application and selecting what type of reminder the user desires to create, the user then generates the reminder by, for example and not in any way as a limitation, typing, taking a picture, recording video or audio, and/or marking points of interest on a map. Then the user selects the appointment details and enters location and time and contact info, for example. Then the user would, in this example, save the reminder and name it, or keep the automatically generated name, and then the user can choose to where to file the reminder and then the user can select the geolocation of the reminder and the proximity to the selected geolocation that would trigger the reminder, which the user can choose to have triggered on entry into the proximity range the user has selected or to trigger when the user leaves said proximity range or to have the reminder triggered in both conditions. At this point, in this example, the user would select the date and time of the reminder and the user can choose to have the reminder repeated randomly, for instance the same time on other days of the week, or at the same time each day of the week, or each day of the week excluding the weekend, or at the same time on the same day of the week each week for a selected period, or the user could select to be reminded every two weeks, or every month, or once a year. The user, in this example, could then choose to passcode protect the reminder and then the user would save the reminder. The system then asks the user whether the user would like to share the reminder and the user selects how to share the reminder and to whom the user would like to share the reminder and then the reminder is so shared. In general, in an aspect, in this embodiment, all information, if possible, about the reminder except the passcode, the radius around the geolocation that was selected by the user, and the category of the reminder is transmitted to all selected recipients. In general, in an aspect, reminders are stored on the user's device; though, for backup purposes, a reminder is stored on a server. If the user wishes to share a reminder the necessary information is sent to a server along with a list of recipients. In general, in an aspect, information is maintained that has been provided by a user, or provided via use of a QR code, matrix code, bar code, or 2D code, about an appointment, such as the time of the appointment and/or the location of the appointment, and an activity to take place in the location of the appointment. This information can be edited at any time and can be re-activated after the selected time has occurred. The information is maintained until the appointed time has occurred and/or the appointed location has been reached but can be reviewed at a later point in time including after the reminder has been triggered and the reminder can be edited at any time. The edited reminder can be shared with others in an editable form for authenticated users of the reminder application. The reminder messages can be delivered at the trigger point in time to others.

Implementations may include one or more of the following features. The information is maintained on a cell phone of the user. The location of the user is determined by a global positioning system (GPS), or via cell tower triangulation, and/or via obtaining the user's Wi-Fi Internet Protocol address. The appointment time is set on a cell phone and compared with local time determined by standard time zones. The activity to be performed at a future time, or the present time, at a different location, or the current location of the user, is entered via voice, text, by taking a picture, dropping pins on a geolocation map, scanning a QR code, or any bar code, matrix code, or 2D code, or choosing an application. In one embodiment the activity is entered by the user via voice commands, in another embodiment the user enters activities via text messaging via the user's cell phone. In another embodiment, the user enters activities via typing. The reminders themselves can be Notes, Pictures, Audio Recordings, Videos, or any combination thereof. The pictures and videos can be new or from the user's smartphone existing camera roll. Audio recording can be new or previously recorded audio files. A map can be used by the user to select locations by dropping pins on said map to highlight certain points of interest (said map contains the geo-coordinates of the dropped pins and, in one embodiment, the address for each pin, and said map is fully scalable). The above are just some example of the smartphone applications that can be utilized by the aforementioned system. After selecting the point of interest users can set a name for the reminder, file the reminder in a certain category, determine the location of where the reminder will go off or the time, and make similar modifications. All reminders are editable by the user.

In general, in an aspect, information is maintained by the user about one or more times for activities and/or about one or more specific locations. The times comprises one or more future times or the present time. The information is maintained until the appointed time or times. At the appointed time or times the user is reminded by text or voice message of the scheduled activity to be engaged in at the specified time and/or at the specific location or a combination of time or times and location or locations. In addition, the user can be reminded of the appointment via text, voice, picture, video, a combination of these, or via the use of another application at the specified time or times and/or location or locations. The user selects the manner in which he is reminded or in the case where the user scanned a QR code, or any bar code, matrix code, or 2D code, he is reminded by the method set in said QR code or bar code, matrix code, or 2D code. These reminders can be re-activated after the time selected has occurred or the location selected has been reached.

In general, in an aspect, a user can provide through an interactive facility information about a time of the appointment, the location of the appointment, and the activity to be engaged in at the specified location and/or specified time(s) and the user can set the size of a perimeter around the specified location, i.e., any distance from 1 meter to 100 kilometers such that if the user enters or alternately leaves the specified zone the reminder is activated.

In general, in an aspect, a storage facility is operated in which information regarding appointment time, appointment location, and the activity or activities to be engaged upon at the appointed time(s) and location are stored. The information regarding the appointment time, appointment location and appointment activity are provided and managed by the user, or via the use of a QR code, or any bar code, matrix code, or 2D code, or via the system itself.

In general, in an aspect, a storage facility is operated in which digital times, geolocation positions, and activities, described digitally, are stored. QR codes, which are analog, are also used in some embodiments.

In general, in an aspect, a communication networking facility enabling individuals to engage in setting appointment times, setting geolocation positions, and selecting, inputting, activities to be engaged upon at the appointed time and/or at appointed location provided by the user or via the use of a QR code, or via the use of any bar code, matrix code, or 2D code, or by the system itself automatically.

In general, in an aspect, a user input module is configured to receive, from a user of a cell phone communication device, instructions to set an appointment time distinct from the present time or not distinct from the present time, instructions to set a specific location distinct from the present location or not distinct from the present location, and instructions to engage in an activity distinct from the present activity. The instructions, in some embodiments, such as use of QR Code, or any bar code, matrix code, or 2D code, information or use of the system to automatically make selections, do not come from the user.

Implementations may include one or more of the following features. A storage means is configured to store the information regarding appointment time, appointment location, and appointment activity. A storage database stores data associated with items stored in the storage means. An appointment configuration means to set up the appointment time, appointment location, and appointment activity which in some embodiments may include a QR reader. A communications means is configured to determine at least either the location or a temporal status of a user. The delivery means is configured to deliver, at the scheduled time, at least either the location or the status of the user's future activity. The display means is configured to display appointment instructions to the user and a representation of the location of the user.

In general, in an aspect, a user who wants to engage in a tangible, physical, virtual, or digital activity at a time and/or in a specific location can provide information from which the activity, the time, and the location can be determined or can provide said information via the use of one or more QR code(s) in combination with the application itself. The QR code could be substituted for by any bar code, matrix code, or 2D code. The information is stored. The user is reminded of the activity at the time and/or in the specific location based on the provided information.

In general, in an aspect, a computer-implemented method includes making information regarding an appointment, a location for the appointment, and an activity at the appointed time and location accessible to the user. In addition, in some embodiments, the user has to set a radius 1 meter to 100 kilometers around the chosen location thus creating a GEO fence such that when the user reaches a point within the chosen perimeter of the chosen location an electronic message reminds the user to engage in the appointed activity when situated at the appointed location at the appointed time.

These and other aspects, features, implementations, and advantages, and combinations of them, can be expressed as methods, apparatus, systems, components, program products, business methods, and means or steps for performing functions, or combinations of these.

Other features, aspects, implementations, and advantages will become apparent from the description, the drawings, and other specifications of the invention.

### DESCRIPTION

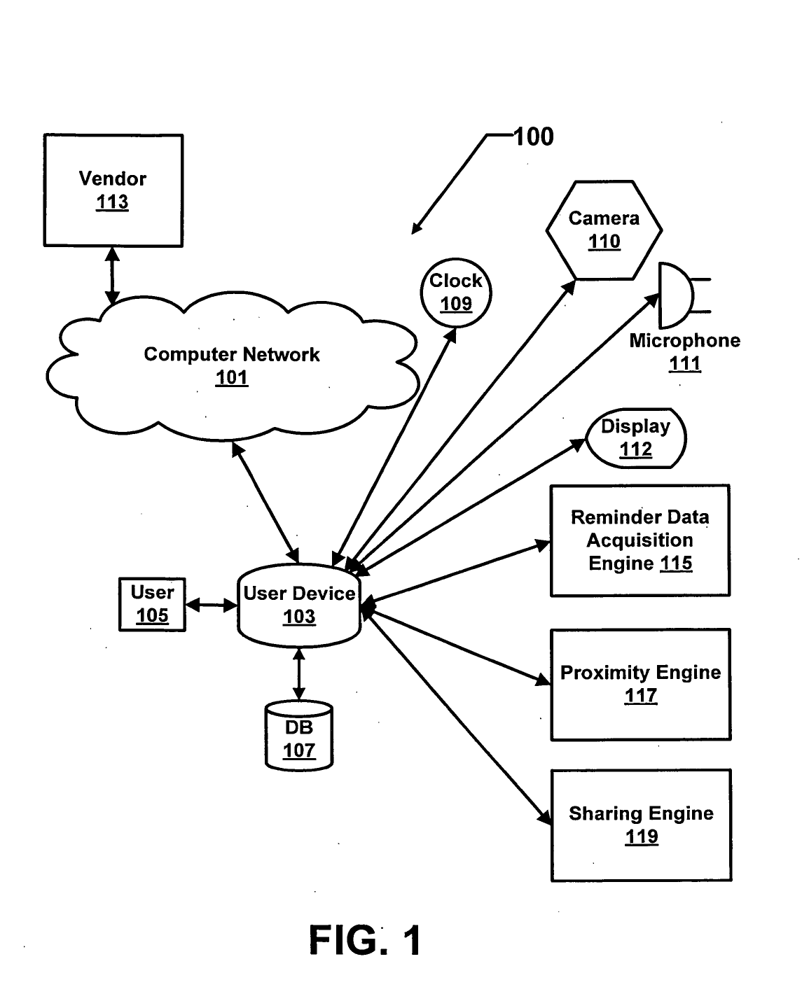

FIG. 1 is a block diagram of a cell phone network or other communication system.

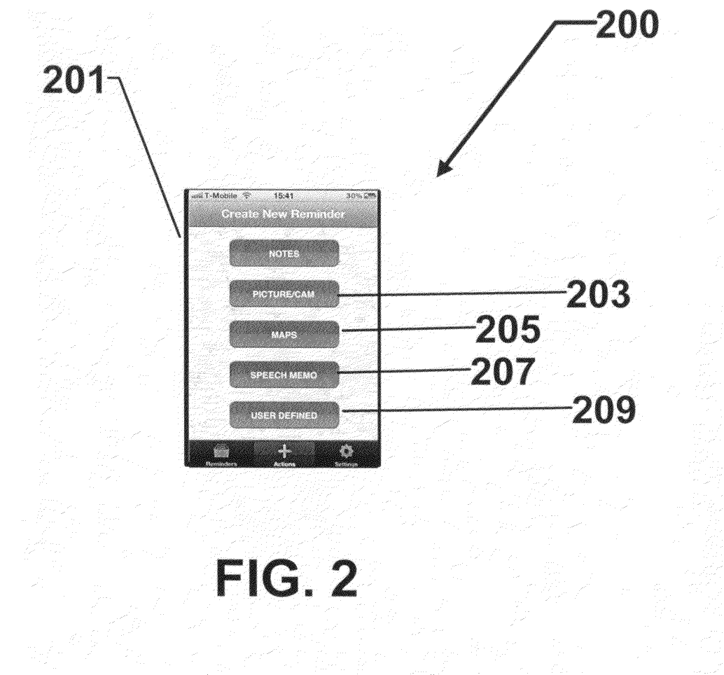

FIG. 2 is a is a view of user interfaces

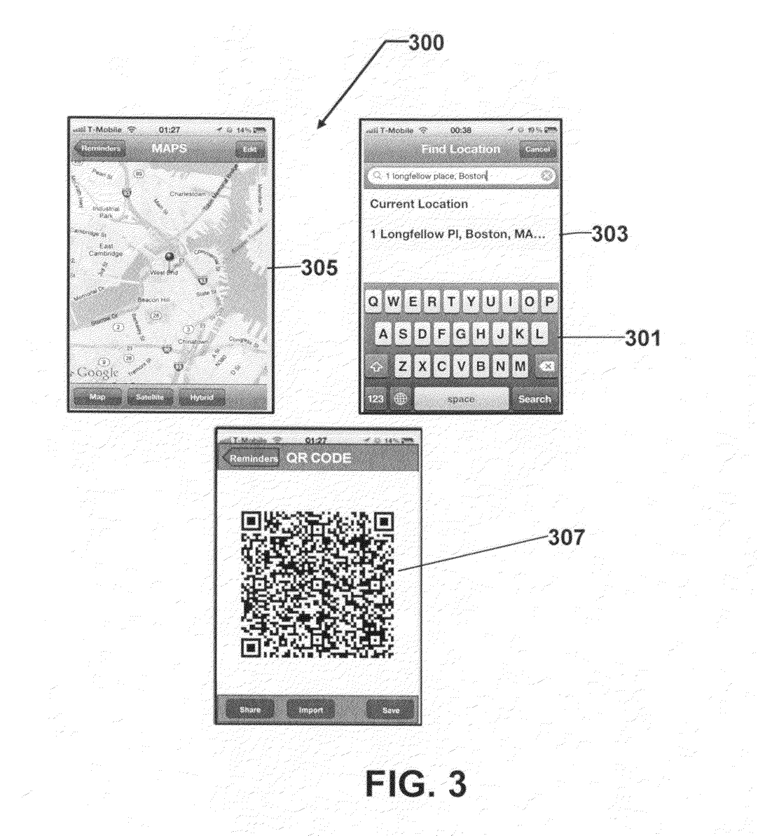

FIG. 3 is a is a view of user interfaces

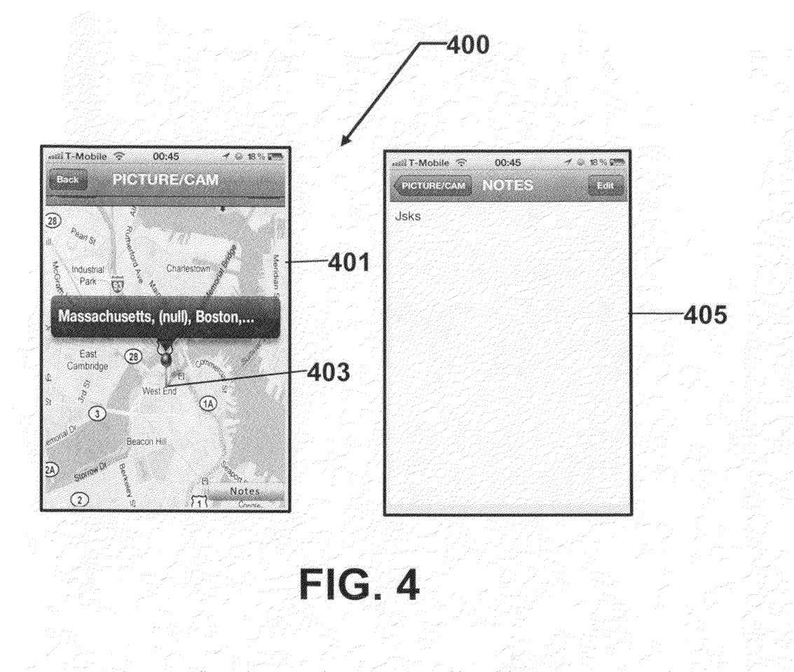

FIG. 4 is a view of user interfaces

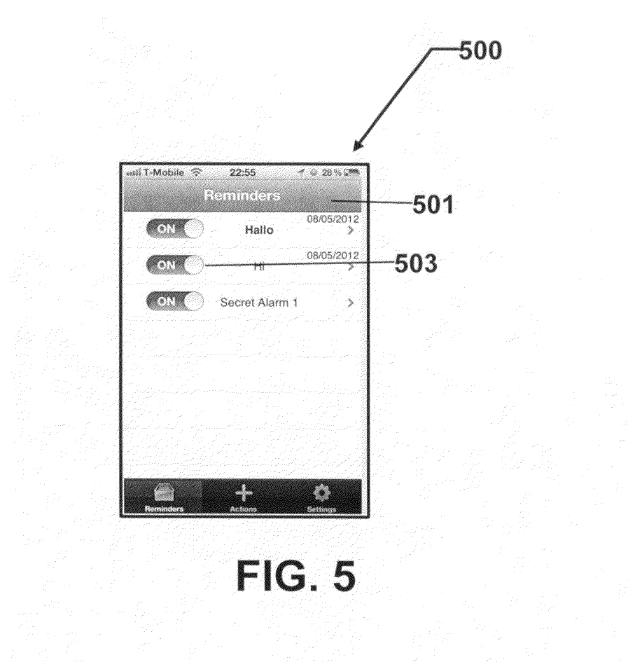

FIG. 5 is a view of a user interface

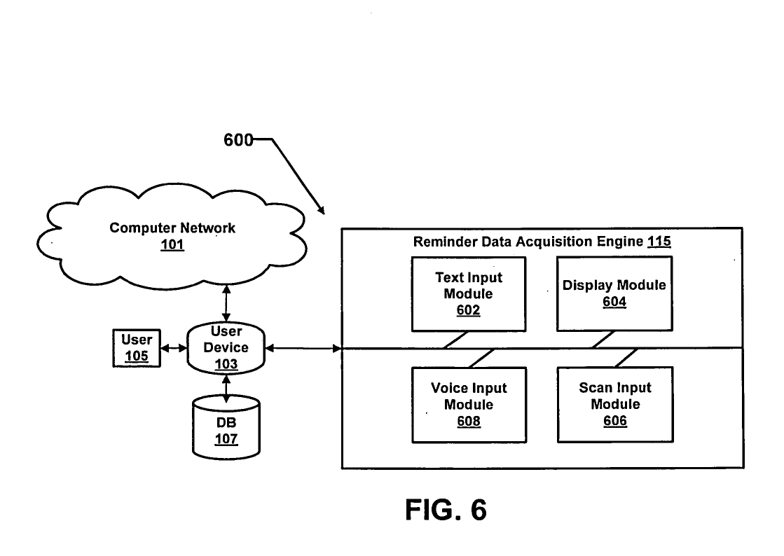

FIG. 6 is a block diagram of a reminder data acquisition engine

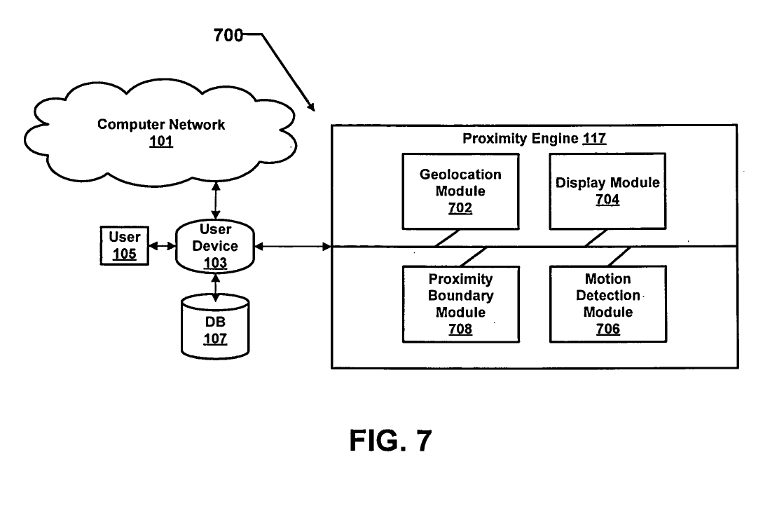

FIG. 7 is a block diagram of a proximity engine.

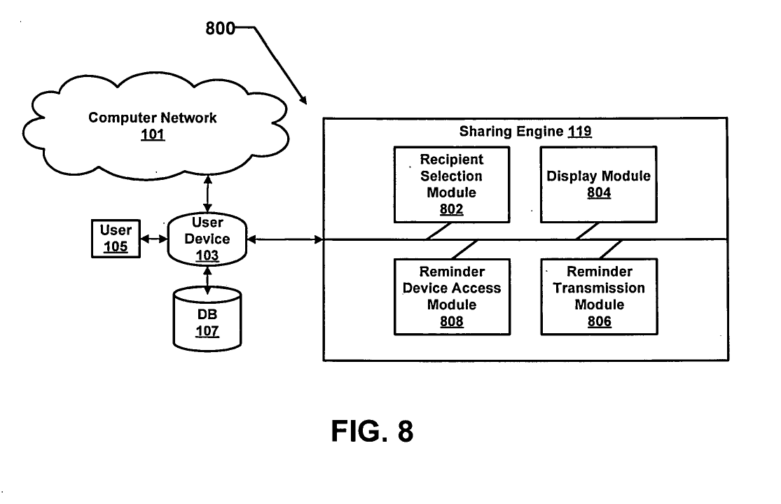

FIG. 8 is a block diagram of a reminder sharing engine.

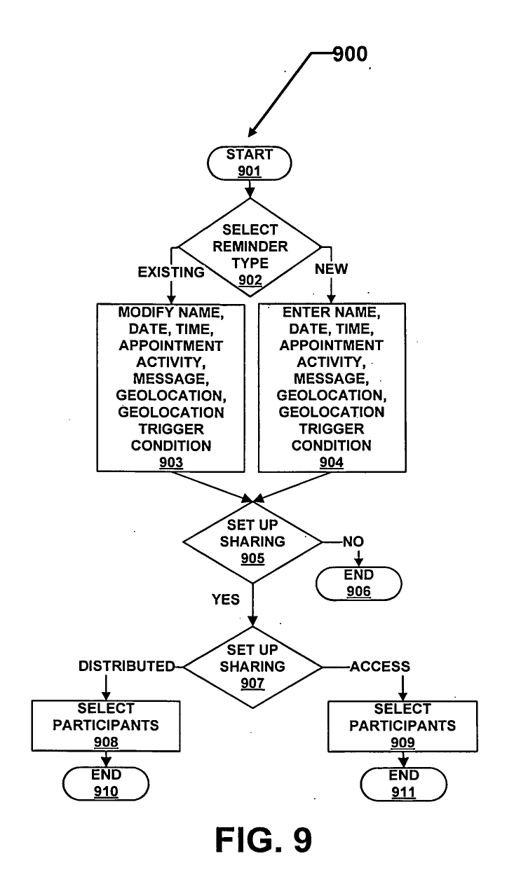

FIG. 9 is a flowchart of a process for generating, editing and transmitting reminders.

The system that we describe here enables members of a community of users of a network, for example, members of a community that includes a group of students, employees of a corporation, or any other group of people or entities to schedule tasks or activities at future times and/or specific locations in such a way that reminders of the task or activity are triggered by proximity to the specific location of the scheduled appointment or arrival of a specific pre-selected time. Implementations of the system need not be limited to networks of the kind known as communication networks, but some implementations will be in the context of communication networks or both. For convenience, we sometimes refer to the system in some examples as a proximity reminder network, but we mean that phrase in a very broad sense to include, for example, any sort of network in which a community of users (we sometimes use the terms users and members interchangeably) participate.

In some examples of the system, the community of users is a limited community that bases inclusion in the community on authentication of members.

We sometimes refer to the community as an authenticated community in a broad sense to mean, for example, that their entitlement to be members of the group can be established by records stored in a database of passwords or in some other way.

An almost limitless variety of tasks, activities, and locations can be the subject of the appointment that we describe here, and we sometimes use the phrase “reminder” to refer to the timely communications of the scheduled appointment in the broadest possible sense.

In implementations of the system that we are describing, appointments typically occur at a future time, which we sometimes call the appointment time. The time can be a specific day and even a specific time on a specific day, or can be defined less specifically as a period of time, e.g., afternoon. In most cases, the appointment time can either be named specifically in advance or conditions for determining the appointment time can be defined, or the appointment time can be determined later in various ways by the system itself or by the system with the help of others.

In some examples, when the appointment time date occurs, the user may be notified by the system, if appropriate. In some cases, the notification may be given by a digital text, voice message, another application, a picture, or a video, and it may trigger an internet link on the communication device held by the user.

The form or context of the reminders made using the system may be auditory, visual, tactile or some combination. The appointments for which reminders are set up can be an unlimited variety of tasks, activities or other events.

Reminder communications through the network may, for example, be, or include, verbal communications, such as text, handwriting, voice recordings, or other types of digital speech; graphs or digital images; video communications; or communications in other media without limit.

In some embodiments, the communication network provides changes in information associated with users of the network such as change of time zone. The resulting reminders may be frequent or automatic or both. Such automatic reminders may be triggered or timed by specific events and may be triggered via use of QR codes or any bar code, matrix code, or 2D code. Thus, the user is able to specify the appointment times, the appointment locations, and the appointment tasks either specifically or by criteria that can be used to determine the specific locations, times, and tasks.

The system can be implemented in a very wide variety of ways as a network in which users of the limited community are participants.

FIG. 1 is a block diagram of an example of the system, e.g., a communication network 101 for scheduling tasks or activities at specific locations and/or at specific times. In this example, the user 105 connects to the communications network 101 with the user devices 103 such as workstations, mobile devices, mobile computers, for communicating across the computer network 101. In some examples, user devices have modules 107 for local storage of data, modules 109 for determining local time, modules 110 for collecting and scanning images, modules 111 for collecting and scanning sounds and voices, modules 112 for displaying maps that may be provided by a vendor 113 located on the communication network 101, data acquisition engine modules 115 for entering and editing information for reminders, proximity engine modules 117 for determining geolocation relative to coordinates from a Global Positioning System, sharing engine modules 119 for providing editable and reminders to others. A user 105 can create, scan, write, dictate, preform, copy, define, or otherwise transcribe reminder messages, enter instructions about appointment tasks, activities, other people, appointment locations and appointment times. Communication network refers to WANs, LANs, the Internet, 3G and 4G networks, or other protocol networks.

FIG. 2 is an example reminder creation interface 200 of a communication network (a system). The user device 103 displays a reminder construction interface 200, which provides a selection list 201 allowing a user to click on the Notes Button 203 to input text, to click on the Picture/CAM Button 205 to input pictures, video images or scan QR codes, or any bar code, matrix code, or 2D code to create a reminder, e.g., related to the appointment location, click on the MAPS Button 207 to drop pins and mark point of interest on one or more maps to display the current location of the user and the location of the appointment, click on the SPEECH MEMO Button 209 to record a voice message, i.e., input reminder instructions by voice, click on the USER DEFINED Button to input special instructions for the scheduled appointment, e.g., a Phone Number and launching another application.

FIG. 3 is an example reminder location specifying interface 300 of a communication network (a system). The user device 103 displays a reminder location construction interface 300, which provides a search-by-text selection 303 allowing a user to input from a virtual keyboard 301 the location of an appointment to search for an address and to click on the Search Button. The user device 103 displays a map 305 with the specified location indicated with optional buttons to display a satellite view or a hybrid view. Alternately, the data for constructing a reminder can be obtained from scanning or importing a QR code 307 and saving the reminder in the storage database 107 of the user device 103. Such a QR code 307 can also be used to share reminders to selected users on a social network by direct scanning of the display on a user's device 103 or communicated over a network 101.

FIG. 4 is an example reminder appointment specifying interface 400 of a communication network (a system). The user device 103 displays a reminder appointment specifying interface 400, which provides a map 401 displaying an appointment geolocation 403 for which a NOTES input display 405 allowing a user to input text for the appointment message with specifications for tasks or activities.

FIG. 5 is an example reminder appointment list interface 500 of a communication network (a system) 101. The user device 103 displays a list of reminders (single reminders as well as categorized reminders) 501. An individual reminder 503 can be turned ON or not.

FIG. 6 is a block diagram 600 of a reminder acquisition engine 119 of the reminder system or other system 100. The reminder data acquisition engine 119 facilitates composition of reminders by the user 105 on the user's device 103 for storage in the reminder data storage 107. A text input module 602 facilitates entry of characters for labeling the reminder, description of the appointment or activity, date of the appointment, time of the appointment, geolocation of the site of the appointment, trigger condition of the appointment reminder, name of the recipient or group of recipients of the reminder. A display module 604 facilitates visualization of reminder data to the user 106 on the user's device 1053 from existing appointments in the reminder data storage 107 and enables construction of appointments through a graphical user interface with selection of geolocation and proximity circle from a map. A voice input module 608 facilitates verbal entry for labeling the reminder, description of the appointment or activity, date of the appointment, time of the appointment, geolocation of the site of the appointment, trigger condition of the appointment reminder, name of the recipient or group of recipients of the reminder. A scan input module 606 facilitates entry from QR codes, matrix codes, bar code or matrix codes for labeling the reminder, description of the appointment or activity, date of the appointment, time of the appointment, geolocation of the site of the appointment, trigger condition of the appointment reminder, name of the recipient or group of recipients of the reminder.

In some embodiments, the reminder data input engine 115 automatically populates the reminder data fields from reminder storage data 107 to facilitate creation of new appointments with minimal modification.

FIG. 7 is a block diagram 700 of a proximity engine 117 of the reminder system or other system 100. The proximity engine 117 facilitates setting the geolocation trigger condition of reminders by the user 105 on the user's device 103 for storage in the reminder data storage 206. A geolocation module 702 facilitates entry of a geographical or landmark location for constructing a reminder. A display module 704 facilitates visualization of reminder geolocation data to the user 105 on the user's device 103 for example as a position with boundary on a visual map from existing appointments in the reminder data storage 107 and enable construction of appointments through a graphical user interface with selection of geolocation and proximity circle from a map. A proximity boundary module 708 facilitates entry and modification of a boundary circle about the geolocation of the appointment site. A motion detection module 706 facilitates specification of the trigger condition relative to the proximity boundary, for example, entering or leaving the boundary zone.

FIG. 8 is a block diagram 800 of a reminder sharing engine 119 of the reminder system or other system 100. The sharing engine 119 facilitates access to reminders by preselected authenticated participants on a social network based on reminders generated by the user 105 on the user's device 103 for storage in the reminder data storage 107. A recipient selection module 702 facilitates selection of authenticated participants on a social network. A display module 704 facilitates visualization of reminder parameters by the user 105 on the user's device 103 for example appointment date, appointment time, appointment activity or message, position with boundary on a visual map with entrance into or exit from proximity zone using date from existing appointments in the reminder data storage 107 and enabling construction of appointments through a graphical user interface appropriate to the preselected participants. A recipient selection module 802 facilitates selection of a recipient or recipients or a group of recipients. A display module 804 facilitates display of reminders at the selected time and geolocation. A reminder device access module 808 facilitates sharing of the reminder data structure on a selected participant's device so that the date, time, and geolocation of the reminder is triggered by the local date, time and geolocation of the selected participant's device but the appointment activity or message is preset by the user. A reminder can be shared by displaying a QR code encapsulating the reminder data that can be scanned or by a reminder transmission module 806 connected to a network 101 that facilitates distribution of the appointment activity description or message when the local date, time and geolocation and trigger condition are satisfied on the user's device 103. For example, when the user reaches a venue for a social gathering such as birthday at the appointed time, a message is send to the invited participants that the user has arrived and the celebrations can begin.

FIG. 9 is a flowchart of an example process 900 for generating, editing reminders by a user 108 on the user's device 103 for storage in a database 107 and optionally transmitting the appointment reminders to a preselected authenticated participant or group of authenticated participants on a social network. In the process 900 an editor user 105 selects, 901, to compose a new appointment reminder (step 903) or modify an existing appointment reminder (step 902). For composing a new appointment reminder the editor user enters text from a physical or virtual keyboard, or scans a quick response code, a matrix code, a bar code or other two dimensional code, or uses a graphical user interface interactively to provide appointment reminder name, date, time, geolocation, and proximity perimeter, geolocation trigger condition for entering or leaving the proximity perimeter or some combination thereof. Alternately, in the process 900, an editor user selects an existing appointment reminder from storage 107 and modifies appointment reminder name, date, time, geolocation, and proximity perimeter, geolocation trigger condition for entering or leaving the proximity perimeter or some combination thereof. In the process 900 a user enters data such as name, date, time, appointment activity, message, geolocation, and geolocation trigger condition, shown in 904. Then the user selects whether to share the reminder with others, 905. In the process 900 the editor user decides to only use the appointment reminder himself 906 or to share the appointment reminder with other participants 907. In the process 900 if the editor user decides to share the appointment reminder with other participants he then further decides to provide access to the appointment reminder 909 on the participant's device or to provide the activity message at the predetermined data, time, and geolocation condition on the editor user's device 908. 910 is the end of the process if the user is using a distributed list of recipients and step 911 is the end of the process if the user is selecting recipients individually.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks. As an example, embodiments may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the communication network has been described in connection with certain examples, is the system is not limited to the disclosed embodiments, but on the contrary, includes various modifications and equivalent arrangements. Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially generated propagated signal, e.g., a machine-generated electrical, optical, or electromagnetic signal, which is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or multiple computers. The apparatus can include special purpose logic circuitry, e.g., a FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. Examples include use of scanners of all sorts and use of microphones. In addition, in one embodiment, a user can scan a QR code and thus input data into the system. The QR code referred to in the previous sentence and throughout this application, can also be any bar code, matrix code, or 2D code. If the user chooses to scan a QR code, the system will use predetermined information and settings to create a reminder for the user. If the QR code is a typical QR code, i.e., not created via the smartphone application described above, then all the information contained in the QR code such as links, addresses, or other parameters will be stored as text in a note reminder. The settings for the name of the reminder, the time and date at which point in time the reminder will be triggered, will be filled in automatically by the system described above. Under settings the user can set and save parameters for reminders and then, after scanning the QR code, determines whether the reminder is time based or location based or both. After setting the reminder the user can change any setting at any time. If the QR code that was scanned by the user was created through the website version of the aforementioned system, then the settings for the reminders will all be generated from the QR code and the user can only edit the reminder once said reminder has been created. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the invention. For example, the actions recited in the description can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other implementations are also within the scope of the invention.

What is claimed is:

1. An apparatus for generating, editing, and transmitting messages comprising a memory that is able to store a reminder data structure consisting of at least one date, at least one time, at least one geolocation, at least one reminder trigger condition, and at least one reminder message in said memory.

2. The apparatus of claim 1 further comprising at least one character input means that a human operator can use to store in said memory at least one of the following: a reminder message, a geolocation, a date, a time, and/or a reminder trigger condition.

3. The apparatus of claim 1 further comprising at least one graphical user interface means that a human operator can use to store in said memory at least one of the following: a reminder message, a geolocation, a date, a time, and/or a reminder trigger condition.

4. The apparatus of claim 1 further comprising at least one graphical user interface means that a human operator can use to select an existing reminder data structure from said memory for editing.

5. The apparatus of claim 1 further comprising at least one graphical user interface means that a human operator can use to select said reminder data structure for transmission at a preselected time, and at least one graphical user interface means that a human operator can use to select entering or leaving a pre-specified geolocation for a said trigger condition for storage in said memory.

6. The apparatus of claim 1 further comprising at least one reminder data structure input means for receiving at least one of the following group (quick response code, matrix code, bar code, two dimensional code) that a human operator can use to input reminder data into said memory and at least one data communication means for transmitting editable reminder data structures to a geolocation-capable communication device of one or more users of said communication device on a social network and at least one data communication means for transmitting executable reminder data structures to a geolocation-capable communication device of one or more users of said communication device on a social network and at least one graphical user interface means that a human operator can use to re-activate an expired reminder transmission.

7. A computer system for generating, editing, and transmitting messages comprising at least one processor that executes the following components: at least one composition component for generating a reminder consisting of at least one trigger condition and at least one message; at least one social network component for selecting users; at least one transmission component sending said reminder to preselected users; at least one memory component for storing said reminder and said users information.

8. The computer system of claim 7 further comprising at least one editing component for the following: modifying a previously generated reminder; re-activating reminder transmissions; and creating custom trigger condition.

9. The computer system of claim 7 further comprising at least one input component for receiving reminder data from one or more of the following: a quick response code; a matrix code, a bar code, a two dimensional code, or any combination of thereof.

10. The computer system of claim 7 further comprising said trigger condition comprising: a calendar date, a day of the week, a time of day, and/or geolocation proximity.

11. The computer system of claim 7 further comprising said trigger condition further comprising: a user entering geolocation proximity, a user leaving proximity, and/or recurrence.

12. The computer system of claim 7 further comprising said trigger condition further comprising: at least one custom criterion and/or any combination thereof.

13. The computer system of claim 7 further comprising: at least one sharing component for sharing editable reminders with pre-selected editor users.

14. A computer-implemented method for providing electronic reminders to recipients comprising: employing at least one processor to execute the following computer-implemented functions: editing reminders from input data comprising at least one date, at least one time, at least one message, at least one geolocation, at least one trigger condition; transmitting reminders to a preselected recipient or group of recipients on a social network; and employing memory to store the reminder data and the preselected recipients.

15. The computer-implemented method of claim 14 further comprising reactivating reminders that have expired.

16. The computer-implemented method of claim 14 further comprising: scanning said input data from one or more of the following: a quick response code, a matrix code, a bar code, a two dimensional code, or a combination thereof.

17. The computer-implemented method of claim 14 further comprising determining proximity of recipient relative to preselected geolocation and tracking motion of recipient relative to preselected geolocation.

18. The computer-implemented method of claim 14 further comprising: editing reminders to recur at a preselected date, a preselected time, a preselected location; or a combination thereof.

19. The computer-implemented method of claim 14 further comprising sharing of editable reminders with at least one preselected user or group of users.

20. The computer-implemented method of claim 14 further comprising sharing executable reminders with at least one preselected user or group of users.
